(19) United States
(12) Patent Application Publication
(10) Pub. No.: US 2026/0217057 A1
(43) Pub. Date: Jul. 30, 2026

(54) Axle Bridge for a Driven Motor Vehicle Axle, Motor Vehicle Axle and Motor Vehicle

(71) Applicant: ZF Friedrichshafen AG, Friedrichshafen (DE)

(72) Inventors: Josef Eimannsberger, Eging am See (DE); Peter Haselberger, Mauth (DE); Liping Shen, Jiaxing (CN); Huaiyang Sun, Suzhou (CN); Yuntao Zhang, Jiaxing (CN); Qiang Zhang, Jiaxing (CN)

(21) Appl. No.: 19/144,847

(22) PCT Filed: Dec. 13, 2023
(86) PCT No.: PCT/EP2023/085484

§ 371 Date: Jun. 30, 2025

(30) Foreign Application Priority Data
Dec. 30, 2022 (CN) 202223570127.6
Dec. 30, 2022 (CN) 202223570129.5

(51) Int. Cl. B60B 35/18; B60B 35/12; B60B 35/16; F16H 48/40

(52) U.S. Cl. CPC B60B 35/18; B60B 35/16; F16H 48/40; B60B 35/122; F16H 2048/405

(57) ABSTRACT

An axle bridge for a driven motor vehicle axle includes an axle body with a first tubular section, a second tubular section, and an annular section between the first and second tubular sections. The axle bridge further includes a support assembly for a differential bearing assembly, the support assembly being supported at the annular section.

### CROSS-REFERENCE TO RELATED APPLICATIONS

The present application is related and has right of priority to Chinese Patent Application Nos. 202223570127.6 and 202223570129.5 each filed on Dec. 30, 2022, and is a nationalization of PCT/EP2023/085484 filed in the European Patent Office on Dec. 13, 2023, each of which is incorporated by reference in their entirety for all purposes.

### FIELD OF THE INVENTION

The invention relates generally to an axle bridge for a driven motor vehicle axle, the axle bridge having an axle body with a first tubular section, a second tubular section, an annular section arranged between the tubular sections, and a support assembly for a differential bearing assembly. The invention also relates generally to a motor vehicle axle having an axle bridge. The invention also relates generally to a motor vehicle having a motor vehicle axle.

### BACKGROUND

Document DE 10 2008 000 446 A1 relates to an axle housing for a motor vehicle, in which a differential gear of a driven axle is accommodated, preferably via two bearings, the axle housing having a first housing part and a second housing part. In order to manufacture an axle housing of this type economically, in particular also for large scale production, the two housing parts are welded together. The axle housing accommodates a differential gear, which is mounted in the axle housing via roller bearings. The differential gear has a crown wheel, which is driven by an internal combustion engine of a motor vehicle via an input pinion.

### SUMMARY OF THE INVENTION

The problem addressed by the invention is that of structurally and/or functionally improving an axle bridge mentioned at the outset. The problem addressed by the invention is also that of structurally and/or functionally improving a motor vehicle axle mentioned at the outset. The problem addressed by the invention is also that of structurally and/or functionally improving a motor vehicle mentioned at the outset.

The axle bridge is for use in a driven motor vehicle axle. The axle bridge has an axle body with a first tubular section, a second tubular section, an annular section, and a support assembly. The annular section is arranged between the first tubular section and the second tubular section. The support assembly is designed and/or arranged to support a differential bearing assembly. The support assembly is arranged at the annular section.

The axle bridge may rigidly connect wheel carriers of a motor vehicle axle to each other. The axle body may be a housing, at least in sections. The axle body may, at least in sections, accommodate and/or rotatably mount components for transmitting propulsive power to vehicle wheels. The axle body can have a first end, which is associated with a first vehicle wheel, and a second end, which is associated with a second vehicle wheel. The axle body can have a longitudinal axis. The longitudinal axis of the axle body can extend between the first end and the second end of the axle body. The first tubular section, the annular section, and the second tubular section can be arranged along the longitudinal axis of the axle body. The longitudinal axis of the axle body can be associated with a transverse axis of the motor vehicle. “Associated” can mean, in particular, in this context, that the longitudinal axis of the axle body is arranged coaxially to or in parallel with the transverse axis of the motor vehicle when the axle body is arranged on a motor vehicle as intended.

In one instance, the first tubular section, the annular section, and the second tubular section are manufactured in one piece. In some instances, the first tubular section, the annular section, and/or the second tubular section are initially manufactured separately from each other and subsequently fixedly connected, in particular welded, to each other. The first tubular section, the annular section, and/or the second tubular section can be manufactured in a casting process. The first tubular section, the annular section, and the second tubular section can form a main axle body of the axle bridge.

The first tubular section and the second tubular section can each be a housing for accommodating and/or rotatably mounting a drive shaft. The first tubular section and the second tubular section can each have a rectangular cross-section, at least in sections. The first tubular section and the second tubular section can each have an axis. The axes of the tubular sections can be arranged coaxially to or in parallel with the longitudinal axis of the axle body.

The annular section can have a circular hollow cylindrical shape with an axis, a casing of the annular section, a base area of the annular section, a cover area of the annular section, and an interior space of the annular section. The axis of the annular section and the longitudinal axis of the axle body can be arranged perpendicularly to each other. The axis of the annular section and the longitudinal axis of the axle body can intersect. The axis of the annular section can be associated with a longitudinal axis of the motor vehicle. “Associated” means, in this context, in particular, that the axis of the annular section has a predetermined orientation relative to the longitudinal axis of the motor vehicle when the axle bridge is arranged on a motor vehicle as intended. When the axle bridge is arranged on a motor vehicle as intended, the axis of the annular section can be slanted horizontally and/or vertically with respect to the longitudinal axis of the motor vehicle. The designations “horizontal” and “vertical” relate, in this context, in particular, to a roadway surface. When the axle bridge is arranged on a motor vehicle as intended, the axis of the annular section can be arranged coaxially to or in parallel with the longitudinal axis of the motor vehicle. The casing of the annular section can have an inner surface. In one instance, the base area of the annular section can be associated with a back of the motor vehicle. In one instance, the base area of the annular section can be associated with a front of the motor vehicle. “Associated” means, in this context, in particular, that the base area of the annular section faces the back of the motor vehicle or the front of the motor vehicle when the axle bridge is arranged on a motor vehicle as intended, and lies in a plane spanned by a transverse axis of the motor vehicle and a vertical axis of the motor vehicle or in a plane parallel to this plane. The cover area of the annular section can be associated with a front of a motor vehicle or a back of a motor vehicle. “Associated” means, in this context, in particular, that the cover area of the annular section faces the front of the motor vehicle or the back of the motor vehicle when the axle bridge is arranged on a motor vehicle as intended, and lies in a plane spanned by a transverse axis of the motor vehicle and a motor vehicle vertical axis or in a plane parallel to this plane. The interior space of the annular section can be delimited by the inner surface of the casing. The annular section, in particular the interior space of the annular section, can be for accommodating a differential.

The differential can be drivable by a bevel gear drive. The bevel gear drive can have a first driving bevel gear with a first driving bevel gear axis and a second driving bevel gear with a second driving bevel gear axis. The first driving bevel gear axis and the second driving bevel gear axis can be arranged offset to each other by 90°. The first driving bevel gear axis and the second driving bevel gear axis can intersect or be arranged askew to each other. The first driving bevel gear axis can be associated with a longitudinal axis of the motor vehicle. “Associated” means, in this context, in particular, that the first driving bevel gear axis has a predetermined orientation relative to the longitudinal axis of the motor vehicle when the differential is arranged on a motor vehicle as intended. When the axle bridge is arranged on a motor vehicle as intended, the first driving bevel gear axis can be slanted horizontally and/or vertically with respect to the longitudinal axis of the motor vehicle. The designations “horizontal” and “vertical” relate, in this context, in particular, to a roadway surface. When the axle bridge is arranged on a motor vehicle as intended, the first driving bevel gear axis can be arranged coaxially to or in parallel with the longitudinal axis of the motor vehicle. The second driving bevel gear axis can be associated with a transverse axis of the motor vehicle. “Associated” means, in this context, in particular, that the second driving bevel gear axis is arranged coaxially to or in parallel with the transverse axis of the motor vehicle when the differential is arranged on a motor vehicle as intended.

The differential can be a bevel gear differential. The differential can have a differential case, the second driving bevel gear, a first output bevel gear, a second output bevel gear, and/or at least one differential pinion. The second driving bevel gear can be connected to the differential case for conjoint rotation. The first output bevel gear can be connectable or connected to a drive shaft, which is associated with the first tubular section, for conjoint rotation. The second output bevel gear can be connectable or connected to a drive shaft, which is associated with the second tubular section, for conjoint rotation. The first output bevel gear, the second output bevel gear, and the at least one differential pinion can be rotatably mounted on the differential case. The differential, in particular the differential case, can be for support and/or mounting on the axle body, in particular on the annular section.

The support assembly supports a differential bearing assembly. The support assembly can axially support a differential bearing assembly. “Axial” corresponds, in this context, in particular, to a direction of extent of the longitudinal axis of the axle body. The support assembly is arranged at the annular section. The annular section can have or define an annular opening. The annular opening can be arranged in the cover area of the annular section. The support assembly can be arranged at or within the annular opening. The annular section can have a further annular opening. The further annular opening can be arranged in the base area of the annular section.

The support assembly can have a support ring. The support ring can be arranged at the annular opening. The support ring can have a radially outer first annular surface, a radially inner second annular surface, a third annular surface facing the axle body, and a fourth annular surface facing away from the axle body. The first annular surface can delimit a circular outer contour of the support ring. The second annular surface can delimit a circular or polygonal inner contour of the support ring. The third annular surface and the fourth annular surface can be planar. The support ring can be arranged concentrically to the annular opening. The support ring can be initially manufactured as a separate component and subsequently fixedly connected, in particular welded, to the annular section. The support ring can be manufactured in a cutting-forming method. The support ring can be manufactured from a metal sheet.

The support assembly can have a first support element, which is associated with the first tubular section. “Associated” means, in this context, in particular, that the first support element is arranged on a side of the annular opening facing the first tubular section. The support assembly can have a second support element, which is associated with the second tubular section. “Associated” means, in this context, in particular, that the second support element is arranged on a side of the annular opening facing the second tubular section. The support elements can be arranged diametrically opposite each other. The support elements can be arranged diametrically opposite each other in the direction of extent of the longitudinal axis of the axle body. The support elements can be arranged on the support ring.

The support elements can each be tab-like and/or step-like. The support elements can each have a first connecting limb associated with the support ring, a second connecting limb associated with the differential bearing assembly, and a third connecting limb connecting the first connecting limb and the second connecting limb. The first connecting limb and the second connecting limb can be arranged in parallel with each other and spaced apart from each other. The third connecting limb can be arranged perpendicularly to the first connecting limb and the second connecting limb. The support elements can each have a support opening. The support opening can be arranged in the second connecting limb. The support opening can be circular. The support elements can be initially manufactured as separate components and subsequently fixedly connected, in particular welded, to the annular section. The support elements can be manufactured in a cutting-forming method. The support elements can be manufactured from a metal sheet.

The support assembly can support a differential bearing assembly with differential bearings, and mounting elements, which are effective between the differential bearings and the support elements. The differential bearing assembly can radially and/or axially support and/or rotatably mount the differential on the axle bridge.

The differential bearing assembly can have a first differential bearing associated with the first tubular section. “Associated” means, in this context, in particular, that the first differential bearing is arranged on a side facing the first tubular section. The differential bearing assembly can have a second differential bearing associated with the second tubular section. “Associated” means, in this context, in particular, that the second differential bearing is arranged on a side facing the second tubular section. The differential bearings can be roller bearings, in particular as tapered roller bearings. The roller bearings can have bearing rings, in particular an inner ring and an outer ring, and rolling elements, in particular tapered rollers, between the inner ring and the outer ring. The roller bearing can be for radial and axial support and/or to transmit radial forces and axial forces. The differential bearings can be arranged to provide support at a slant. The mounting elements can radially and axially fix a differential case.

The differential bearing assembly can have a first mounting element associated with the first tubular section. “Associated” means, in this context, in particular, that the first mounting element is arranged on a side facing the first tubular section. The differential bearing assembly can have a second mounting element associated with the second tubular section. “Associated” means, in this context, in particular, that the second mounting element is arranged on a side facing the second tubular section. The mounting elements can radially and axially fix a differential case, in particular indirectly.

The first mounting element and the second mounting element can be arranged in the interior space of the annular section. The first mounting element can have a bearing holder for the first differential bearing. The first mounting element can be fixedly connected via its bearing holder to a bearing ring of the first differential bearing. The first mounting element can be supported against the first support element. The first mounting element can have an extension. The first mounting element can be accommodated via its extension in the support opening in the first support element, in particular for axial support and/or for transmitting axial forces. The second mounting element can have a bearing holder for the second differential bearing. The second mounting element can be fixedly connected via its bearing holder to a bearing ring of the second differential bearing. The second mounting element can be supported against the second support element. The second mounting element can have an extension. The second mounting element can be accommodated via its extension in the support opening in the second support element, in particular for axial support and/or for transmitting axial forces.

The motor vehicle axle has the axle bridge. The motor vehicle axle can have a differential. The motor vehicle axle can have a differential bearing assembly. The differential can be radially and/or axially supported and/or rotatably mounted on the axle bridge using the differential bearing assembly. The motor vehicle axle can have a cover for the annular opening. The cover can have the shape of a spherical cap. The motor vehicle axle can have a further cover for a further annular opening. The motor vehicle axle can have further components, for example, components for connection to a vehicle body, bearings, wheel carriers, wheels, and/or brake components.

The motor vehicle has the motor vehicle axle. The motor vehicle can be a passenger car, a motor bus, a truck, an agricultural or forestry tractor, a self-propelled work machine, such as a construction machine, or any other type of motor vehicle, such as an industrial vehicle.

In summary and expressed in other words, the invention therefore yields, among other things, a weld-on axle bridge with axle drive bearings or an “axle insert support.” The axle insert, when fitted in a weld-on axle bridge, can be positioned by two simple bearing plates, which can be welded to the axle body.

With the aid of the invention, power flow between the support assembly and the main axle body is optimized. Mass can be reduced. Further components of the motor vehicle axle can be designed with a reduced wall thickness. An expense, such as costs, is reduced. A number of required welding seams can be reduced. An acoustic operating behavior can be improved.

### BRIEF DESCRIPTION OF THE DRAWINGS

In the following, exemplary embodiments of the invention are described in greater detail with reference to figures. Schematically and by way of example:

FIG. 1 shows a driven motor vehicle axle with an axle bridge, a differential bearing assembly supported by a support assembly, and a differential in a perspective view, and

FIG. 2 shows a driven motor vehicle axle with an axle bridge, a differential bearing assembly supported by a support assembly, and a differential in a sectional view.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

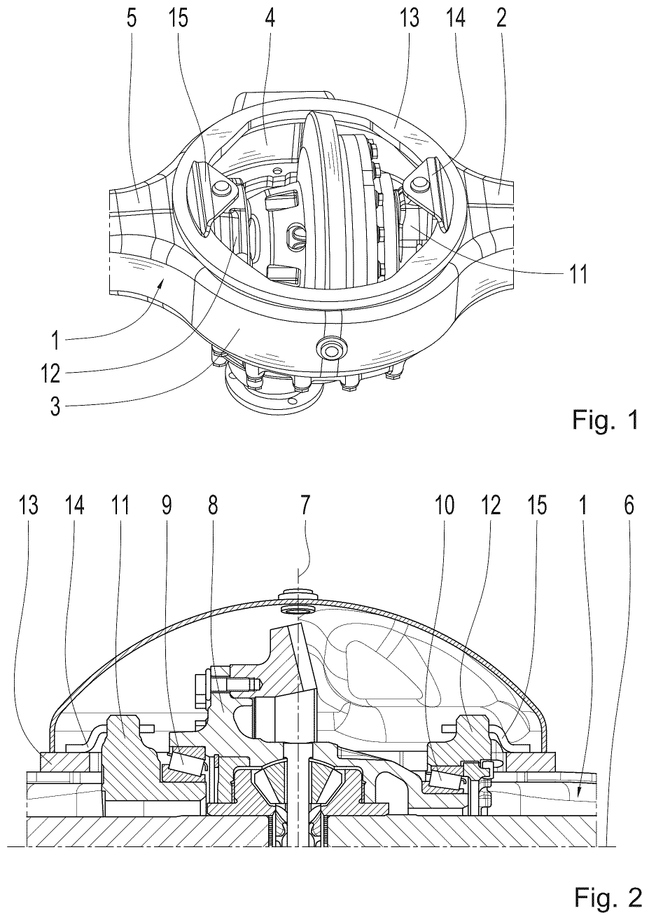

FIG. 1 shows a portion of a driven motor vehicle axle with an axle bridge, a differential, and a differential bearing assembly, and FIG. 2 shows the axle bridge in a sectional view. The axle bridge has an axle body 1 with a first tubular section 2, an annular section 3 with an annular opening 4, and a second tubular section 5. A longitudinal axis 6 of the axle body 1, and an axis 7 of the annular section 3 are particularly shown in FIG. 2.

The differential has a differential case 8. The differential bearing assembly has differential bearings 9, 10 and mounting elements 11, 12. The differential bearings 9, 10 are tapered roller bearings and each have an inner ring, an outer ring, and rolling elements. The differential case 8 has bearing holders on which the differential bearings 9, 10 are accommodated via their rings. The mounting element 11 has a bearing holder for the differential bearing 9 and is fixedly connected to the inner ring of the differential bearing 9. The mounting element 12 has a bearing holder for the differential bearing 10 and is fixedly connected to the outer ring of the differential bearing 10. The mounting elements 11, 12 each have an extension.

The axle body 1 has a support assembly for the differential bearing assembly. The support assembly has a support ring 13 and support elements 14, 15. The support ring 13 is arranged concentrically to the annular opening 4 and is welded to the annular section. The support elements 14, 15 are each tab-like, each have a connecting limb with a support opening, and are welded to the support ring 13, the support elements 14, 15 being arranged diametrically opposite each other in the direction of extent of the longitudinal axis of the axle body 6.

The mounting element 11 is accommodated via its extension in the support opening in the support element 14. The mounting element 12 is accommodated via its extension in the support opening in the support element 15. The differential case 8 is thus mounted for transmitting, in particular, axial forces. Power can flow from the differential case 8 via the differential bearings 9, 10, the mounting elements 11, 12, the support elements 14, 15, and the support ring 13 to the axle body 1.

The term “can” refers, in particular, to optional features of the invention. Accordingly, there are also developments and/or exemplary embodiments of the invention that, additionally or alternatively, have the particular feature or the particular features.

Features can also be extracted, if necessary, from the combinations of features disclosed with the description, and, after resolving a structural and/or functional relationship that may exist between the features, can be used alone or in combination with other features to delimit the subject matter of the claim.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 axle body
2 first tubular section
3 annular section
4 annular opening
5 second tubular section
6 longitudinal axis of the axle body
7 axis of the annular section
8 differential case
9 differential bearing
10 differential bearing
11 mounting element
12 mounting element
13 support ring
14 support element
15 support element

1-13. (canceled)

14. An axle bridge for a driven motor vehicle axle, the axle bridge comprising:
an axle body (1) with a first tubular section (2), a second tubular section (5), and an annular section (3) between the first and second tubular sections (2, 5); and
a support assembly for a differential bearing assembly, the support assembly being supported at the annular section (3).

15. The axle bridge of claim 14, wherein the annular section (3) defines an annular opening (4), the support assembly being supported at the annular opening (4).

16. The axle bridge of claim 15, wherein the support assembly comprises a support ring (13).

17. The axle bridge of claim 16, wherein the support ring (13) is concentric to the annular opening (4).

18. The axle bridge of claim 16, wherein the support ring (13) is manufactured as a separate component from the annular section (3) and subsequently fixedly connected to the annular section (3).

19. The axle bridge of claim 16, wherein the support assembly comprises a first support element (14) associated with the first tubular section (2), and a second support element (15), associated with the second tubular section (5).

20. The axle bridge of claim 19, wherein the first support element (14) and the second support element (15) are diametrically opposite each other.

21. The axle bridge of claim 19, wherein one or both of:
each of the first support element (14) and the second support element

(15) is tab-like; or
each of the the first support element (14) and the second support element (15) defines a support opening.

22. The axle bridge of claim 19, wherein the first support element (14) and the second support element (15) are at the support ring (13).

23. The axle bridge of claim 22, wherein the first support element (14) and the second support element (15) are manufactured as separate components from the support ring (13) and subsequently fixedly connected to the support ring (13).

24. The axle bridge of claim 19, wherein the support assembly supports a differential bearing assembly having differential bearings (9, 10) and mounting elements (11, 12), the mounting elements (11, 12) being between the differential bearings (9, 10) and the first and second support elements (14, 15).

25. A motor vehicle axle, comprising the axle bridge of claim 14.

26. A motor vehicle, comprising the motor vehicle axle of claim 25.
